(19) United States
(12) Patent Application Publication
(10) Pub. No.: US 2002/0078722 A1
(43) Pub. Date: Jun. 27, 2002

(54) Lock protector for dispensing machines

(75) Inventor: Ashley M. Corey, Chandler, AZ (US)

Correspondence Address: C. Robert von Hellens, CAHILL, SUTTON & THOMAS P.L.C., 155 Park One, 2141 East Highland Avenue, Phoenix, AZ, 85016, US

(73) Assignee: Jan's Iron Works, Inc.

(21) Appl. No.: 09/746,287

(22) Filed: Dec. 21, 2000

(51) Int. Cl. E05B 13/10

(52) U.S. Cl. 70/208

(57) ABSTRACT

Snack and drink dispensers include a lockable pivoting door that provides access to the interior for refilling dispensed items and for retrieving cash collected. A lockable T-handle having key operated locking lugs extending from the T-handle penetrably engage slots in an encircling sleeve to prevent partial withdrawal of the T-handle from a recess in the door and thereby prevent rotation of the T-handle to unlock the door. Inserts of steel or the like are located in the opposed arms of the T-handle to prevent destruction of the locking lugs by drilling through the arms into contact with the locking lugs.

### BACKGROUND OF THE INVENTION

1. Field of the Invention

The present invention relates to locks for snack and drink dispensing machines and, more particularly, to a security device for preventing destruction of a lock for locking the door of the dispensing machine.

2. Description of Related Art

Snack and/or drink dispensing machines have been in use for decades. Typically, such a dispensing machine will dispense a selectable snack, drink or other item upon insertion of one or more coins into a coin slot followed by actuation of a selector for selecting the snack, drink or item desired. Some dispensing machines may also incorporate a bill changer. The coins and bills inserted to pay for the item selected are collected in a cashbox internal to the dispensing machine. Usually, a lockable pivotable door is opened to provide access to the cashbox and to permit refilling of items dispensed.

Typically, a dispensing machine of the type described above includes a T-handle recessed within the door which is lockable in the recessed state. Upon unlocking the T-handle, the T-handle is withdrawn from the recess in an amount sufficient to clear the arms of the T-handle and permit rotation of the T-handle. Upon rotation of the T-handle, an engaged rod is turned to unlatch the door from a locked position. Thereafter, the door may be swung open to provide access to the interior of the dispensing machine.

The T-handle incorporates a key operated lock in the base of the T-handle. By turning a key when the T-handle is in the recessed position, one or more lugs extend laterally therefrom into locking engagement with an aperture in a cylindrical element surrounding the base. Alternatively, a bar or the like located proximate the lug(s) may provide the locking engagement. The engagement of the lug with the aperture precludes withdrawal of the T-handle from within the recess. Variations of such lugs and apertures or latch plates are known.

The T-handle is usually of a die cast zinc composition. This material is relatively soft and easy to drill with a drill bit secured in a conventional portable electric drill. Thieves have been known to drill through the arms of the T-handle into contact with a locking lug to destroy the locking lug(s) extending from the base of the T-handle. Upon such destruction, the T-handle is easily withdrawn from its recess and thereafter rotated to open the door of the dispensing machine. Because of the relative softness of the material of the T-handle and the locking lug(s), the destruction of the locking lug(s) can be accomplished in a minute or so. Such rapidity in destroying the lock of the door of a dispensing machine permits a thief very quick access to the contents of a dispensing machine and minimizes the exposure time of being caught in the act of robbing the dispensing machine.

### SUMMARY OF THE INVENTION

The present invention is directed to apparatus for thwarting destruction of the lock of a conventional snack and/or drink dispensing machine and thereby prevents theft of the cash and the contents of the dispensing machine. In particular, the present invention is directed to inserts that may be retrofitted in the arms of a conventional T-handle used to lock conventional dispensing machines. Such inserts are of hardened material to frustrate any attempt to drill through the arms for purposes of destroying a locking lug or lugs shielded from access by the arms.

It is therefore a primary object of the present invention to provide a restraint against breaking into a dispensing machine by drilling out the locking lugs.

Another object of the present invention is to provide a retrofit locking T-handle for a dispensing machine which effectively precludes destruction of the locking lugs securing the door of the dispensing machine.

Still another object of the present invention is to provide hardened inserts for the arms of a locking T-handle used in conjunction with dispensing machines to prevent drilling through the arms of the T-handle.

A further object of the present invention is to provide a T-handle having a security feature for use with a dispensing machine.

A still further object of the present invention is to provide an inexpensive modification to a locking T-handle for a dispensing machine which will significantly impede destruction of the locking lugs maintaining the door of the dispensing machine locked.

A yet further object of the present invention is to provide a method for reconstructing locking T-handles for dispensing machines which enhances the security of the dispensing machines.

These and other objects of the present invention will become apparent to those skilled in the art as the description thereof proceeds.

### BRIEF DESCRIPTION OF THE DRAWINGS

The present invention will be described with specificity and clarity with reference to the following drawings, in which:

FIG. 1 is a partial isometric view of a snack and/or drink dispensing machine incorporating a lockable T-handle constructed in accordance with the present invention;

FIG. 2 is an isometric view of the T-handle;

FIG. 3 is a cross sectional view of the T-handle;

FIG. 4 is a cross sectional view taken along lines 4-4, as shown in FIG. 3;

FIG. 5 is a cross sectional view illustrating the T-handle in the extracted position;

FIG. 6 is a cross sectional view taken along lines 6-6, as shown in FIG. 5; and

FIG. 7 is a partial cross sectional view taken along lines 7-7, as shown in FIG. 5.

### DESCRIPTION OF THE PREFERRED EMBODIMENT

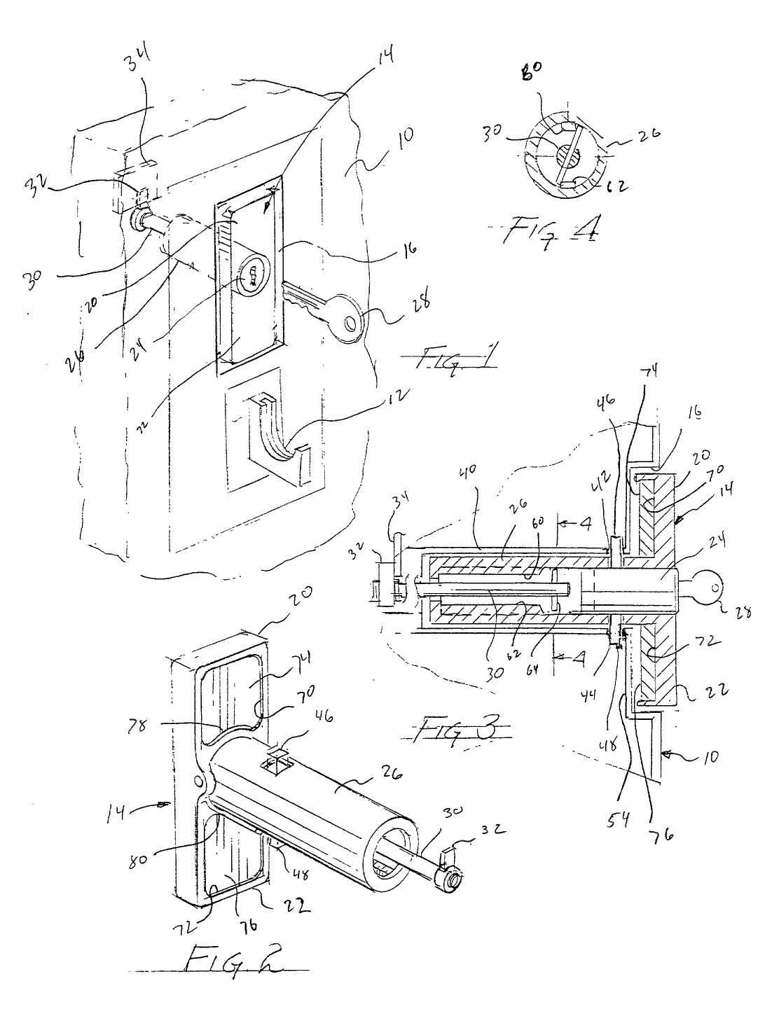

Referring to FIG. 1, there is illustrated a part of a door 10 pivotally attached to a conventional snack and/or drink dispensing machine (not shown). Such a door includes a slot 12 for receiving coins in payment for the snack or drink to be dispensed. Some dispensing machines may include a bill changer to permit payment by inserting a bill rather than one or more coins. The money inserted is collected in a cashbox within the dispensing machine accessible by opening door 10. A T-handle 14 is recessed within a recess 16 when in the locked position, as shown. The configuration of the recess may be generally commensurate with the planform of opposed arms 20, 22 of the T-handle. A conventional cylindrical lock 24 is disposed within base 26 of the T-handle. A key 28 is used to engage lock 24 and perform the conventional function of locking and unlocking the lock. A rod 30 is in axial alignment with base 26. The distal end of the rod includes a latch 32 pivotally engagable with a latch plate 34 mounted in or attached to the body of the dispensing machine. Upon unlocking lock 24, T-handle 14 may be withdrawn from within recess 16. Upon such withdrawal, the T-handle may be rotated. Upon withdrawal of the T-handle it functionally engages rod 30 whereby the rod will rotate commensurate with rotation of the T-handle. Such rotation will bring latch 32 into and out of engagement with latch plate 34 attached to the body of the dispensing machine. Thereby, T-handle 14 and lock 24 control opening and unlocking of door 10 and closing of the door into a locked state.

Referring to FIGS. 2 and 3, further details of the T-handle and its operation will be described. Base 26 of T-handle 14 is insertable within a cylindrical receiver 40 disposed in door 10. One or more opposed apertures 42, 44 in the receiver accommodate penetration and withdrawal of one or more locking lugs 46, 48, respectively. That is, upon turning key 26 in one direction, lugs 46, 48 will extend laterally into engagement with apertures 42, 44, respectively. Alternatively, bars or the like for selective engagement by the locking lugs may be used in place of the apertures. Such engagement precludes withdrawal of handle 14 from within recess 16. Typically, the recess is defined by a metal sheet 54 defining the exterior surface of door 10. Furthermore, the locking lugs preclude rotation of handle 14. Without such rotation, latch 32 is retained in engagement with latch plate 34. As the latch plate is attached to an anchoring element within the dispensing machine, door 10 cannot be swung open while latch 32 is in engagement with latch plate 34. Upon turning key 28 to unlock lock 24, locking lugs 46, 48 are withdrawn from within apertures 42, 44, respectively, in receiver 40. Such withdrawal of the locking lugs permits drawing T-handle 14 out of recess 16.

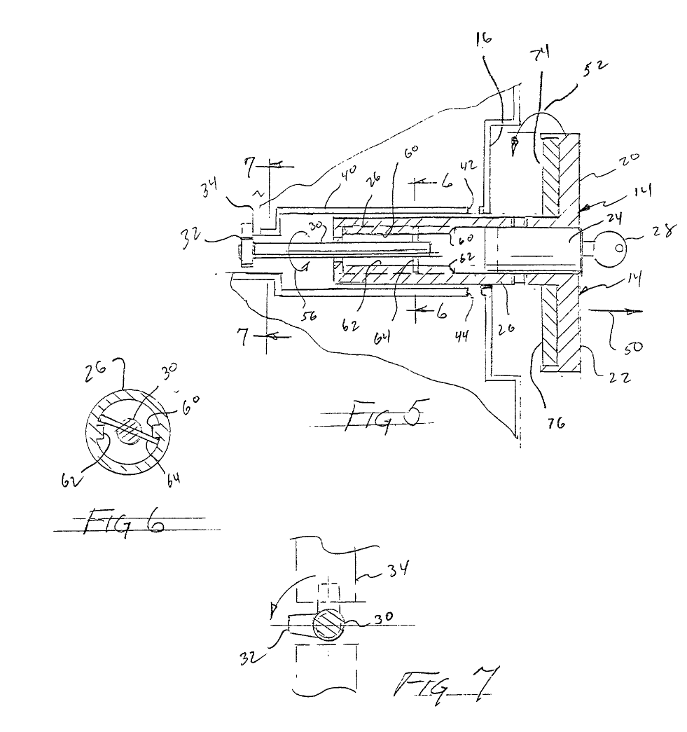

As shown jointly in FIGS. 3, 4, 5, 6 and 7, retraction of locking lugs 46, 48 permits rectilinear translation of the T-handle to withdraw the T-handle from the recess, as depicted by arrow 50 shown in FIG. 5. Thereafter, the T-handle may be rotated, as depicted by arrow 52, which results in rotation of rod 30, as depicted by arrow 56. The interior of casing 26 includes a pair of radially inwardly extending longitudinally oriented lands 60, 62 in diametrically opposed locations. Rod 30 includes a pin 64 extending radially in opposed directions. As shown in FIG. 3, the proximal end of lands 60, 62 terminate short of pin 64 when T-handle 14 is in the recessed position. As the T-handle is withdrawn, as shown in FIG. 5, lands 60, 62 comes into interfering engagement with pin 64, as shown in FIG. 6. Upon rotation of the T-handle, lands 60, 62 will bear against opposed ends of pin 64 resulting in rotation of rod 30 commensurate with rotation of the T-handle. Such rotation will result in rotation of latch 32 out of interfering engagement with latch plate 34, as shown in FIGS. 5 and 7. Upon a further pull of the T-handle, door 10 will swing open.

By inspection, it becomes apparent that if locking lugs 46, 48 were destroyed in their extended position, as shown in FIGS. 2 and 3, no impediment would exist to withdraw the T-handle from within recess 16 and thereafter permit rotation of rod 30 to unlatch and open the door.

T-handle 14 is conventionally made of a die cast zinc material, which material is relatively easy to drill with a conventional drill bit mounted upon a portable electric drill. Thieves have learned that they can drill through arms 20, 22 quickly and with relative ease. The material of locking lugs 46, 48 used in conventional cylindrical locks 24 of the type shown and widely used, is also relatively easy to drill. Thus, a conventional portable hand drill with a suitably sized drill bit can be used to quickly drill through the arms of T-handle into contact with the locking lugs and destroy them. With such destruction of the locking lugs, no impediment exist to withdraw the T-handle and permit opening door 10 of the dispensing machine. Thus, the contents of the dispensing machine, particularly the cash in the cashbox, can be quickly stolen.

Referring particularly to FIGS. 2 and 3, there is shown an improvement to T-handle 14 which effectively precludes rapid and facile destruction of locking lugs 46, 48. The inside of arm 20 is routed out to form a cavity 70. A similar cavity 72 is formed in arm 22. An insert 74 is located within cavity 70 and an insert 76 is located within cavity 72. These inserts may be of steel or other hard material which is difficult and time consuming to penetrate with a drill bit of a conventional portable hand drill. The inserts may be wedged in their respective cavities. Alternatively, and to permit greater tolerance of the cavities formed commensurate with the planform of the insert, an adhesive or mastic of some type, such as a dab of epoxy, may be used to retain the inserts in place. The means for retaining the inserts in place is not critical since they are incapable of sliding sideways due to the walls of the respective cavities and expulsion of the inserts from within their cavities is precluded by interference with sheet metal 54 forming recess 16 in door 10.

With the inclusion of such inserts in a T-handle used in conjunction with conventional dispensing machines, it becomes essentially impossible to drill through arms 20, 22 to bring a drill bit into engagement with either of locking lugs 46, 48. Thus, destruction of the locking lugs within a limited time period in which a thief has to act to reduce the probability of being caught is essentially precluded.

Typically, the depth of cavities 70, 72 is on the order of ⅛ inch. Likewise, the thickness of inserts 74, 76 may be on the order of ⅛ inch if they are of steel. Other hard materials may be of greater or lesser thickness but generally commensurate with the depth of the cavities. As shown, the cavities are generally rectangular in planform. To minimize the risk of drilling through the arms in the space between inside edge 78, 80 of inserts 74, 76, respectively, the cavities and inserts may be curved as shown to permit placing the inserts as close as possible to the exterior cylindrical surface of base 26.

While the invention has been described with reference to several particular embodiments thereof, those skilled in the art will be able to make the various modifications to the described embodiments of the invention without departing from the true spirit and scope of the invention. It is intended that all combinations of elements and steps which perform substantially the same function in substantially the same way to achieve the same result are within the scope of the invention.

I claim:

1. An improvement of a T-handle useable with a conventional dispensing machine, said improvement comprising in combination:
a) a pair of arms of the T-handle extending in opposed directions from a base of the T-handle, each arm of said pair of arms including a front surface and a rear surface;
b) a cavity formed in the rear surface of each arm of said pair of arms; and
c) an insert disposed in each of said cavities, each said insert being of hard and difficult to drill material.

2. An improvement of a T-handle as set forth in claim 1 including means for securing each of said inserts in one of said cavities.

3. An improvement of a T-handle as set forth in claim 1 wherein each cavity is generally rectangular in planform.

4. An improvement of a T-handle as set forth in claim 3 wherein each said insert is generally rectangular in planform and locatable within one of said cavities.

5. An improvement of a T-handle as set forth in claim 1 wherein the material of each of said inserts is steel.

6. An improvement of a T-handle as set forth in claim 1 wherein the thickness of each of said inserts is about ⅛ inch.

7. In a dispensing machine for dispensing a product in response to insertion of money into the dispensing machine having a T-handle disposed in a door of the dispensing machine for locking the door in the closed position upon at least partial insertion of the arms of the T-handle into a recess in the door and extending at least one locking lug from the base of the T-handle into locking engagement with a part of the door and for opening the door upon disengagement of the at least one locking lug by retracting the at least one locking lug into the base, withdrawing the T-handle from the recess and rotating the T-handle, said improvement comprising an insert of hard and difficult to drill material inserted into each arm of the T-handle to prevent drilling through at least one of the arms to the at least one locking lug and destroying the at least one locking lug with a drill bit.

8. The improvement as set forth in claim 7 wherein each of said inserts is of steel.

9. The improvement as set forth in claim 7 wherein each arm of the T-handle includes a rear surface juxtaposed with the recess and a cavity disposed in each rear surface for receiving one of said inserts.

10. The improvement as set forth in claim 9 wherein each of said cavities extends into the respective arm about ⅛ inch.

11. The improvement as set forth in claim 7 wherein each of said inserts is about ⅛ inch thick.

12. The improvement as set forth in claim 9 wherein each of said cavities is generally rectangular in planform.

13. The improvement as set forth in claim 12 wherein each of said inserts is generally rectangular in planform.

14. A T-handle for use in a dispensing machine for opening, closing and locking a door of the dispensing machine in the closed position, said T-handle comprising in combination:
a) a casing adapted to be located within the door for operating a latch to lock the door in place, said casing including a lock having at least a locking lug extendable in an extended state into the door to prevent rotation and rectilinear translation of said T-handle;
b) a pair of arms extending from said casing in opposed directions, each arm of said pair of arms including a rear surface and a front surface;
c) a cavity disposed in the rear surface of each of said arms; and
d) an insert of hard difficult to drill material adapted to be disposed in each of said cavities to restrain a drill bit from drilling through each arm of said pair of arms and into said at least one locking lug in the extended state.

15. A T-handle as set forth in claim 14 including means for securing each insert of said pair of inserts in the respective one of said cavities.

16. A T-handle as set forth in claim 15 wherein said securing means is an adhesive.

17. A T-handle as set forth in claim 14 wherein each insert of said pair of inserts is of steel.

18. A T-handle as set forth in claim 14 wherein each cavity of said pair of cavities is generally rectangular in planform to receive a commensurately configured insert of said pair of inserts.

19. A T-handle as set forth in claim 14 wherein each insert of said pair of inserts is about ⅛ inch thick.

20. A T-handle as set forth in claim 19 wherein each cavity of said pair of cavities is about ⅛ inch deep.
